(19) United States
(12) Patent Application Publication
(10) Pub. No.: US 2015/0332347 A1
(43) Pub. Date: Nov. 19, 2015

(54) METHOD AND SYSTEM FOR CROWDSOURCING ADVERTISING

(71) Applicant: Timothy Gil LeCroix, Clermont, FL (US)

(72) Inventor: Timothy Gil LeCroix, Clermont, FL (US)

(21) Appl. No.: 14/711,439

(22) Filed: May 13, 2015

Related U.S. Application Data
(60) Provisional application No. 61/992,705, filed on May 13, 2014.

(51) Int. Cl. G06Q 30/02; G06Q 50/00

(52) U.S. Cl. CPC G06Q 30/0273; G06Q 50/01

(57) ABSTRACT

A crowdsourcing system is presented having an open environment to advertisers to participate in crowdsourcing projects. Flexible and customizable fee arrangements with the advertisers serve to reduce fees to the project owners of the crowdsourcing projects and, in some cases, provide free rewards to donors to the projects.

### RELATED APPLICATIONS

The present application is co-pending with, claims priority to, and is a Non-Provisional of Provisional Application Ser. No. 61/992,705, entitled “Method and System for Crowdsourcing Advertising,” filed on May 13, 2014, and the disclosure of which is incorporated by reference herein in its entirety.

### BACKGROUND

Crowdsourcing leverages the power of social interactions to achieve some desired goal. In most cases, this goal is generating funds for some purposes (sometimes referred to as crowdfunding).

Typically, with crowdsourcing a platform is created that allows individuals to create projects that explain what the goal of the project is and permits others to participate in that goal. An individual that creates the project is the project owner.

Existing crowdsourcing platforms rely on fees to provide the projects within the platforms. These fees are rigidly based on either fees deducted from the project owners of the project or fees grossed up to donors that donate to a project. This is unattractive to the project owners because revenues generated are decreased, and this is unattractive to potential donors that may want all their donations to go directly to the projects to which they want to make those donations.

Moreover, crowdsourcing platforms are closed meaning related and unrelated products or services are generally not permitted within the projects. This is unfortunate because some projects may have a significant number of visitors (donors or potential donors) to those projects, which means the platforms' owners and the projects' owners of the projects, within those platforms, are missing out on significant lost potential opportunities.

Therefore, there is a need for improved crowdsourcing platform models and techniques.

### SUMMARY

Various embodiments of the invention provide a method and a system for crowdsourcing. In an embodiment, a method for operating a crowdsourcing platform is presented.

Specifically, a crowdsourcing project is defined and an advertiser is identified to advertise within the crowdsourcing project. Next, project fees are dynamically adjusted for operating the crowdsourcing project based on advertiser fees provided by the advertiser.

### BRIEF DESCRIPTION OF THE DRAWINGS

FIG. 1 is a diagram depicting crowdsourcing system, according to an example embodiment.

FIG. 2 is a diagram of a method for crowdsourcing, according to an example embodiment.

FIG. 3 is a diagram of another method for crowdsourcing, according to an example embodiment.

FIG. 4 is a diagram of a crowdsourcing system, according to an embodiment.

### DETAILED DESCRIPTION

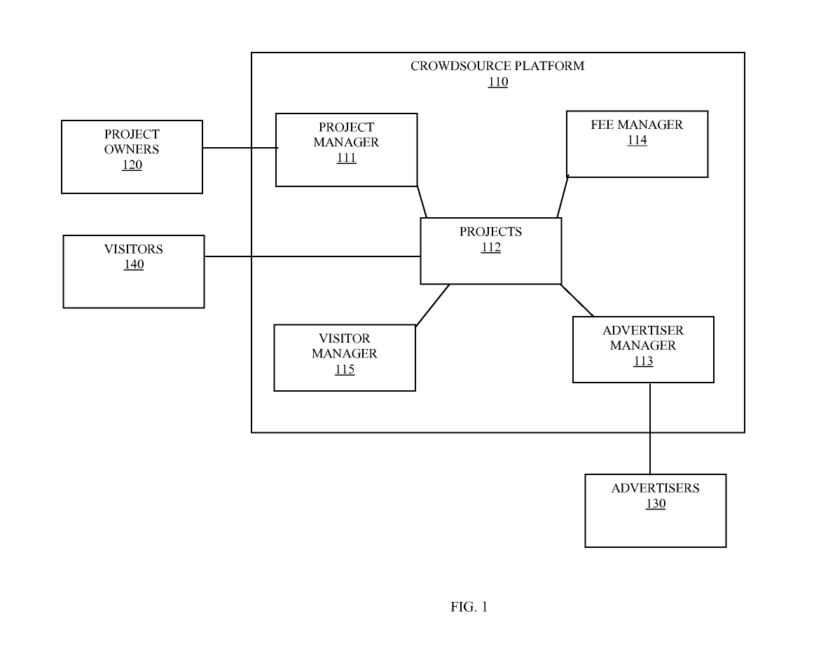

FIG. 1 is a diagram depicting crowdsourcing system, according to an example embodiment. It is noted that the system depicted in the FIG. 1 is shown in greatly simplified form with just those components necessary for understanding the teachings presented herein and below presented.

Moreover, the system of the FIG. 1 is one example illustration of how a crowdsourcing architecture may be arranged to achieve the crowdsourcing techniques presented herein. It is noted that other arrangements may be used without departing from the teachings presented herein.

The components 111-115 are implemented in non-transitory computer-readable storage medium(s) as executable instructions that are executed by one or more hardware processors. The executable instructions may be programmed into memory for the device having the executable instructions.

The crowdsourcing system includes a crowdsource platform 110 having a project manager 111, projects 112, an advertiser manager 113, a fee manager 114, and a visitor manager 115. Project owners 120, advertisers 130, and visitors 140 interact with the components 111, 113, and 112, respectively.

The crowdsource platform 110 includes one or more servers having the hardware processors that execute the instructions associated with the components 111-115.

In an embodiment, the crowdsource platform 110 is a website.

In an embodiment, the crowdsource platform 110 is a logical arrangement of geographically dispersed servers organized as a cloud processing environment.

The project manager 111 is responsible for defining the projects 112. Each project 112, at least partially defined by attributes and goals defined by a particular project owner 120 (through an interactive interface between a device operated by that project owner and the project manager 111).

A “project” 112 as used herein is a defined activity, product, and/or service that is being proposed or offered by a particular project owner 120. In an embodiment, each project 112 is a defined processing environment within the crowdsource platform 110 as defined by the project manner 111 through interactions with a particular project owner 120. In an embodiment, each project 112 is its own web portal.

The advertiser manager 113 interacts with each of the projects 112 in a manner defined by the attributes defined for the projects 112 (attributes defined by the project manager 111). Moreover the advertiser manager 113 interacts (though interfaces) to advertisers 130 (advertisers 130 can include automated third-party advertising systems in which case the interface is an Application Programming Interface (API)).

The fee manager 114 flexibly defines how fees are collected from advertisers 130 for each project 112 (as defined by the project attributes) and/or how fees are collected or reduced for the project owners 120 for each product 112 (as defined by the project attributes).

The visitor manager 115 monitors all activity of visitors 140 to the projects 112 for purposes of auditing, accounting, and reporting.

It is noted that each of the components 111-115 may interface and interact with one another through API interfaces (although not completely shown in the FIG. 1).

During operation of the system, a project owner 120 access an interface associated with the project manager 111 to define the attributes for a project 112. At this time, the project manager 111 may propose some advertisers 130 that may be of interest to the project owner to offset any fees associated with the project 112. The project manager 111 may propose the advertisers 130 based on a category or subject associated with the project 112 (as defined through the interface in the project attributes).

By default, the project manager 111 may propose an initial fee structure for the project 112 by interacting with the fee manager 114, and, perhaps, based on the project category (although this does not have to be the case). The interface between the project manager 111 and the project owner 120 may then propose alternative fee arrangements or potential reduction in fees to the default fee arrangement based on agreed to advertisers 130 or advertisers 130 selected by the project owner 120 through the interface to the project manager 111.

A variety of fee arrangements can be proposed or selected and such fee arrangements are configurable within the fee manager 114.

For example, an advertiser 130 may agree through the advertiser manager 113 to be a sponsor to the project 112 for any number of reasons, such as the social issue is of interest to the advertiser 130 (adopt a dog); the goal of the project 112 is related to the business of the advertiser 130 (adopt a dog and the advertiser sells dog food); the goal of the project is likely to generate a lot of traffic and interest from the visitors 140, which could in turn generate business for products or services of the advertiser 130; and the like. A sponsor (advertiser 130 in the present running example) may agree to provide a free reward to a visitor 140 for making a donation to the project (such as a tee shirt, free dog food, free dog collar, etc.) to entice the donor (visitor 140 to the project 112 in the running example) to donate to the project 112. This increases the potential revenue for the project 112 and increases visibility to the advertiser 130 while being free to the project owner 120 of the project 112 (which is conventionally not the case in the industry where rewards provided are often expensed to the project owner 112).

The advertiser 130 may agree to provide donations to the project 112 based on the number of visitors 140 to the project 112; based on the number of visitors 140 that click on an advertisement of the advertiser 130 presented with the project 120; and/or based the number of visitors 140 that purchase a good or service associated with the advertisement (which may be a discounted offer for the good or server of the advertiser 130).

The advertiser 130 may also agree to provide a set flat fee for providing an advertisement within the project.

The various fees agreed to be paid by the advertiser 130 for the project 112 does not have to be exclusive (meaning multiple different fee arrangements may exist for a single advertiser 130 to a given project 112).

Additionally, the fees are accounted for by the fee manager 114 (for each project 112) in combination with the visitor manager 115 and/or advertiser manager 113.

Still further, the fees collected by the fee arrangement with the project owner 120 are collected by the operator of the crowdsource platform 110 and can be used to reduce fees associated with the operator hosting and managing collection of donations to the project 112 on behalf of the project owner 120. In other words, if enough fees are collected from the advertiser 130 for the operator of the platform 110 to cover operating expenses and, perhaps, a reasonable profit, then the project owner 120 may operate the project 112 so as to collect 100% of all donations made by donating visitors 140. In fact, in some instances the project owner 120 can receive funds in excess of 100% of all donations made, such as when the advertisement fees are in excess of the reasonable profit expected by the operator of the platform 110.

It is noted that each project 112 may include multiple advertisements from a same advertiser 130 and/or multiple advertisements from different advertisers 130. The project owners 120 are given control over the advertisers 130 selected based on the fee arrangements and options presented to the project owners 120 through the interface to the project manager 111 when the projects 112 are defined by the project owners 120.

It is noted also that the advertisers 130 may be related to the project category assigned in the project attributes for the project 112 and/or may be wholly unrelated to the project category. Again, control of this may be given to the project owners 120 when defining the project attributes through the project manager 111.

The reduction in fees to the project owner 120 may also result in reduction in expenses to the donors (visitors 140 that make donations). This can occur because an advertiser 130 offers a reward for a donation (such as a tee shirt), which is free to the donor (absorbed by the advertiser 130). Conventionally, this is not the case because conventional crowdsource platforms charge for any rewards provided to the donor and then provides some nominal credited amount back to the project 112 based on the charge.

It is now apparent how the crowdsource platform 110 provides an improved crowdsourcing solution to what is presently available in the industry. This is done by making projects 112 flexible and open environment to advertisers 130 desiring to have exposure within the projects 112 with control remaining with the project owners 120. This is also done by providing flexible fee arrangements to project owners 120 and advertisers 130 in the manners discussed above and below, such that fees can be reduced to zero or below zero (additional funds beyond just donations to the projects 112) to the project owners 120. Moreover, making donations can be made more attractive to donors (visitors 140) by providing free reward inducements as provided by the advertisers 130.

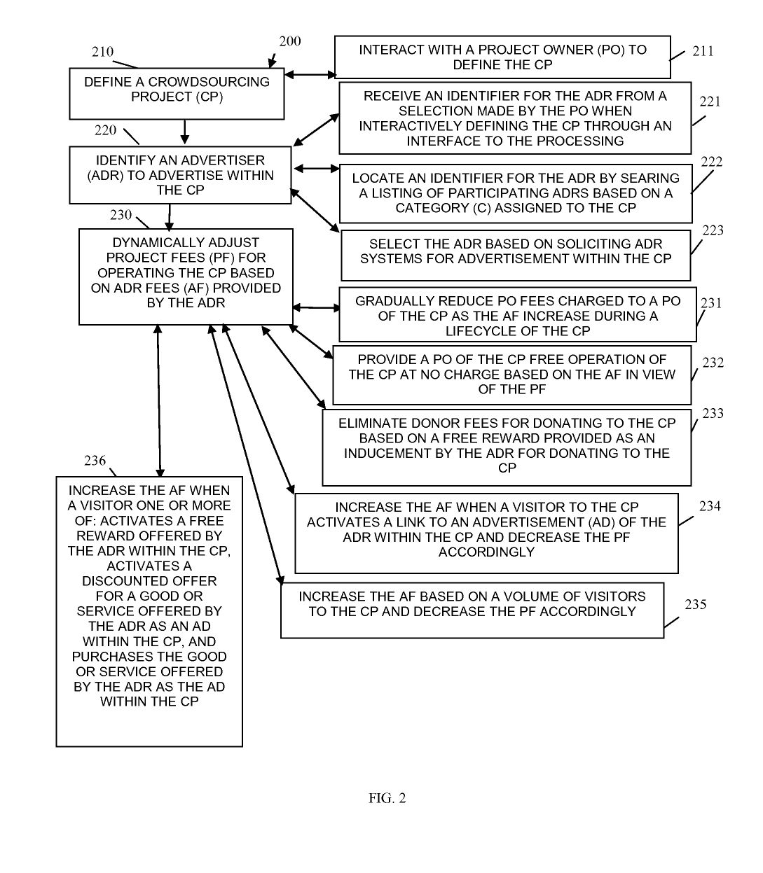

These and other embodiments are now discussed with reference to the FIGS. 2-4.

FIG. 2 is a diagram of a method 200 for crowdsourcing, according to an example embodiment. The method 200 is implemented as one or more software modules (herein after referred to as “crowdsourcing project manager”). The crowdsourcing project manager includes executable instructions that are implemented, programmed, and resides within memory and/or a non-transitory computer-readable storage media; the executable instructions execute on one or more hardware processors of a server machine and have access to one or more network connections associated with one or more networks. The networks may be wired, wireless, or a combination of wired and wireless.

In an embodiment, the crowdsourcing project manager processes on a server.

In an embodiment, the crowdsourcing project manager processes on the server that includes the crowdsource platform 110 of the FIG. 1.

In an embodiment, the crowdsourcing project manager processes on multiple servers that comprise a cloud processing environment.

In an embodiment, the crowdsourcing project manager one or more of the software components 111-115 of the FIG. 1.

At 210, the crowdsourcing project manager defines a crowdsourcing project (herein after just “project”).

According to an embodiment, at 211, the crowdsourcing project manager interacts with a project owner to define the project. This is done through an interface associated with a device operated by the project owner and the crowdsourcing project manager over a network connection. In an embodiment, the interface is a web-based interface.

At 220, the crowdsourcing project manager identifies an advertiser to advertise within the project. This can be done in a variety of manners.

For example, at 221, the crowdsourcing project manager receives an identifier for the advertiser from a selection made by the project owner when interactively defining the project though an interface (such as a web-based interface) to the crowdsourcing project manager.

In an embodiment, at 222, the crowdsourcing project manager locates an identifier for the advertiser by searching a listing of participating advertisers based on a category assigned to the project. In one case, the listing is based on advertisers that have registered for advertising within projects with the crowdsourcing project manager.

According to an embodiment, at 223, the crowdsourcing project manager selects the advertiser based on soliciting advertiser systems for advertisement within the project. This can be done through an API interface between the crowdsourcing project manager and the advertiser systems in an automated fashion.

At 230, the crowdsourcing project manager dynamically adjusts project fees for operating the project based on advertiser fees provided by the advertiser.

In an embodiment, at 231, the crowdsourcing project manager gradually reduces the project fees charged to a project owner of the project as the advertiser fees increase during a lifecycle of the project.

According to an embodiment, at 232, the crowdsourcing project manager provides a project owner of the project with free operation of the project at no charge based on the advertiser fees and in view of the project fees associated with operating the project and other projects unrelated to the project.

In an embodiment, at 233, the crowdsourcing project manager eliminates donor fees for donating to the project based on a free reward provided as an inducement by the advertiser for donating funds to the project.

In an embodiment, at 234, the crowdsourcing project manager increases the advertiser fees when a visitor to the project activates a link to an advertisement of the advertiser within the project and decreases the project fees accordingly based on the increased advertiser fees.

In an embodiment, at 235, the crowdsourcing project manager increases the advertiser fees based on a volume of visitors to the project and decreases the project fees according based on the increased advertiser fees.

According to an embodiment, at 236, the crowdsourcing project manager increases the advertiser fees when a visitor to the project performs one or more of: activates a free reward offered by the advertiser within the project, activates a discounted offer for a good or service offered by the advertiser as an advertisement, and/or purchases the good or the service offered by the advertiser as the advertisement within the project.

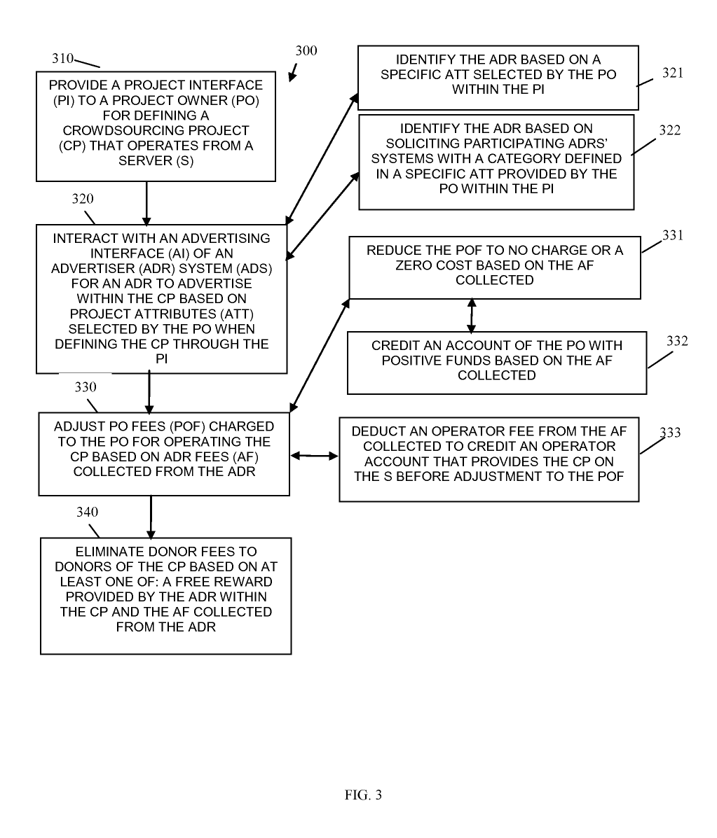

FIG. 3 is a diagram of another method 300 for crowdsourcing, according to an example embodiment. The method 300 is implemented as one or more software module(s) (herein after referred to as “crowdsourcing platform manager”) on a device. The crowdsourcing platform manager is represented as executable instructions that are implemented, programmed, and resides within memory and/or a non-transitory machine-readable storage medium; the executable instructions execute on one or more processors of a hardware device and have access to one or more network connections associated with one or more networks. The networks may be wired, wireless, or a combination of wired and wireless.

In an embodiment, the crowdsourcing platform manager executes on a server.

In an embodiment, the crowdsourcing platform manager executes on a server associated with the crowdsource platform 110 of the FIG. 1.

In an embodiment, the crowdsourcing platform manager is an enhanced version of the crowdsourcing project manager of the FIG. 2.

In an embodiment, the crowdsourcing platform manager is one or more of the software components 111-115 of the FIG. 1.

At 310, the crowdsourcing platform manager provides (or presents) a project interface to a project owner for defining a crowdsourcing project (herein after “project”) that operators from a server of a set of servers (which may or may not be a cloud processing environment).

At 320, the crowdsourcing platform manager interacts with an advertising interface of an advertiser system for an advertiser to advertise within the project based on project attributes selected and provided by the project owner when defining the project through the project interface at 310.

According to an embodiment, at 321, the crowdsourcing platform manager identifies the advertiser based on a specific project attribute selected by the project owner within the project interface at 310.

In an embodiment, at 322, the crowdsourcing platform manager identifies the advertiser based on soliciting participating advertisers' systems with a category defined in a specific project attribute provided by the project owner within the project interface at 310.

At 330, the crowdsourcing platform manager adjusts project owner fees charged to the project owner for operating the project based on advertiser fees collected from the advertiser.

In an embodiment, at 331, the crowdsourcing platform manager reduces the project owner fees to no charge or a zero cost based on the amount collected for the advertiser fees.

In an embodiment of 331 and at 332, the crowdsourcing platform manager credits an account of the project owner with positive funds based on the amount collected for the advertiser fees.

In an embodiment, at 333, the crowdsourcing platform manager deducts an operator fee from the advertiser fees collected to credit an operator account that provides the project platform environment on the server(s) before adjustment is made to the project owner fees.

According to an embodiment, at 340, the crowdsourcing platform manager eliminates donor fees to donors of the project based on at least one or more of: a free reward provided by the advertiser within the project and the advertiser fees collected from the advertiser.

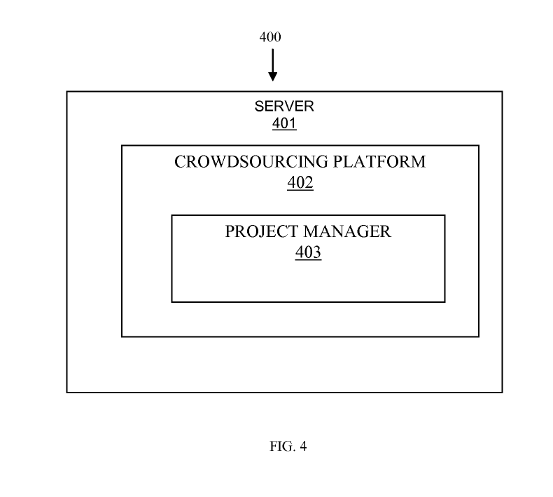

FIG. 4 is a diagram of a crowdsourcing system 400, according to an embodiment. Various components of the crowdsourcing system 400 are software module(s) represented as executable instructions, which are programed and/or reside within memory and/or non-transitory computer-readable storage media for execution by one or more physical server machines and their hardware processors. The components and the physical server machines have access to one or more network connections over one or more networks, which are wired, wireless, or a combination of wired and wireless.

In an embodiment, the crowdsourcing system 400 implements, inter alia, the system depicted in the FIG. 1, the method 200 of the FIG. 2, and the method 300 of the FIG. 3. Accordingly, embodiments discussed above with respect to the FIGS. 1-3 are incorporated by reference herein with the discussion of the wireless information passing and authentication system 400.

The crowdsourcing system 400 includes a server 401, a crowdsourcing platform 402, and a project manager 403.

In an embodiment, the server 401 is a plurality of geographical dispersed servers logically organized as a cloud processing environment.

In an embodiment, the crowdsourcing platform 402 is a logical processing environment provided within the server 401.

In an embodiment, the crowdsourcing platform 402 is the crowdsource platform 110 of the FIG. 1.

The project manager 403 is configured and adapted to: execute on the server 401, manage crowdsourcing projects (herein after “projects”) operating within the crowdsourcing platform 402, and dynamically adjust project fees charged to project owners of the projects based on advertiser fees collected from advertisers that advertise within the projects.

In an embodiment, the project manager 403 is further configured and adapted to: collect an operator fee for an operator of the projects from the advertiser fees before adjusting the project fees charged to the project owners.

In an embodiment, the project manager 403 is the method 200 of the FIG. 2.

In an embodiment, the project manager 403 is the method 300 of the FIG. 3.

In an embodiment, the project manager 403 is one or more of the software components 111-115 of the FIG. 1.

In an embodiment, the project manager 402 is a one or more combinations of the FIGS. 1-3.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method for operating a crowdsourcing project, comprising:
defining, at a server, the crowdsourcing project;
identifying, by the server, an advertiser to advertise within the crowdsourcing project; and
dynamically adjusting, by the server, project fees for operating the crowdsourcing project based on advertiser fees provided by the advertiser.

2. The method of claim 1, wherein defining further includes interacting with a project owner to define the crowdsourcing project.

3. The method of claim 1, wherein identifying further includes receiving an identifier for the advertiser from a selection made by a project owner when interactively defining the crowdsourcing project through an interface to the method.

4. The method of claim 1, wherein identifying further includes locating an identifier for the advertiser by searching a listing of participating advertisers based on a category assigned to the crowdsourcing project.

5. The method of claim 1, wherein identifying further includes selecting the advertiser based on soliciting advertiser systems for advertisement within the crowdsourcing project.

6. The method of claim 1, wherein dynamically adjusting further includes gradually reducing project owner fees charged to a project owner of the crowdsourcing project as the advertiser fees increase during a lifecycle of the crowdsourcing project.

7. The method of claim 1, wherein dynamically adjusting further includes providing a project owner of the crowdsourcing project free operation of the crowdsourcing project at no charge based on the advertiser fees in view of the project fees.

8. The method of claim 1, wherein dynamically adjusting further includes eliminating donor fees for donating to the crowdsourcing project based on a free reward provided as an inducement by the advertiser for donating to the crowdsourcing project.

9. The method of claim 1, wherein dynamically adjusting further includes increasing the advertiser fees when a visitor to the crowdsourcing project activates a link to an advertisement of the advertiser within the crowdsourcing project and decreasing the project fees accordingly.

10. The method of claim 1, wherein dynamically adjusting further includes increasing the advertiser fees based on a volume of visitors to the crowdsourcing projected and decreasing the project fees accordingly.

11. The method of claim 1, wherein dynamically adjusting further includes increasing the advertiser fees when a visitor one or more of: activates a free reward offered by the advertiser within the crowdsourcing project, activates a discounted offer for a good or a service offered by the advertiser as an advertisement within the crowdsourcing project, and purchases the good or service offered by the advertiser as the advertisement within the crowdsourcing project.

12. A method for operating a crowdsourcing project, comprising:
providing, at a server, a project interface to a project owner for defining the crowdsourcing project that operates from the server;
interacting, from the server, with an advertising interface of an advertiser system for an advertiser to advertise within the crowdsourcing project based on project attributes selected by the project owner when defining the crowdsourcing project through the project interface; and
adjusting, by the server, project owner fees charged to the project owner for operating the crowdsourcing project based on advertiser fees collected from the advertiser.

13. The method of claim 12 further comprising, eliminating donor fees to donors of the crowdsourcing project based on at least one of: a free reward provided by the advertiser within the crowdsourcing project and the advertiser fees collected from the advertiser.

14. The method of claim 12, wherein interacting further includes identifying the advertiser based on a specific project attribute selected by the project owner within the project interface.

15. The method of claim 12, wherein interacting further includes identifying the advertiser based on soliciting participating advertisers' systems with a category defined in a specific project attribute provided by the project owner within the project interface.

16. The method of claim 12, wherein adjusting further includes reducing the project owner fees to no charge or a zero cost based on the advertiser fees collected.

17. The method of claim 16, wherein reducing further includes crediting an account of the project owner with positive funds based on the advertiser fees collected.

18. The method of claim 12, wherein adjusting further includes deducting an operator fee from the advertiser fees collected to credit an operator account that provides the crowdsourcing project on the server before adjusting the project owner fees.

19. A system, comprising:
a server configured to provide a crowdsourcing platform;
a project manager configured to: i) execute on the server within the crowdsourcing platform, ii) manage crowdsourcing projects operating on the crowdsourcing platform, and iii) dynamically adjust project fees charged to project owners of the crowdsourcing projects based on advertiser fees collected from advertisers that advertise within the crowdsourcing projects.

20. The system of claim 19, wherein project manager is further configured to: iv) collect an operator fee for an operator of the crowdsourcing projects from the advertiser fees before adjusting the project fees charged to the project owners.
